(19) United States
(12) Patent Application Publication
(10) Pub. No.: US 2026/0010148 A1
(43) Pub. Date: Jan. 8, 2026

(54) RECORDING MEDIUM, SERVICE-LINKAGE CONTROL METHOD, AND SERVICE-LINKAGE CONTROL SYSTEM

(71) Applicant: Fujitsu Limited, Kawasaki-shi (JP)

(72) Inventors: Shoichi KOGISO, Nagoya (JP); Daiki YOSHIKAWA, Handa (JP); Atsushi WATAKI, Ota (JP)

(73) Assignee: Fujitsu Limited, Kawasaki-shi (JP)

(21) Appl. No.: 19/256,238

(22) Filed: Jul. 1, 2025

(30) Foreign Application Priority Data
Jul. 5, 2024 (JP) 2024-109112

(51) Int. Cl. G05B 19/418

(52) U.S. Cl. CPC G05B 19/41865; G05B 2219/31449

(57) ABSTRACT

A non-transitory computer-readable recording medium stores therein a service-linkage control program that causes a computer to execute a process including determining whether a monitoring condition in which a condition for monitoring a monitoring target that operates on a service is set is defined in a job flow using a plurality of services, monitoring a service based on the monitoring condition when it is determined that the monitoring condition is defined in the job flow, and transitioning, when a transition condition in which a condition for the service to transition to a next service is set is satisfied as a result of the monitoring, the service to the next service based on the job flow.

### CROSS-REFERENCE TO RELATED APPLICATION

This application is based upon and claims the benefit of priority of the prior Japanese Patent Application No. 2024-109112, filed on Jul. 5, 2024, the entire contents of which are incorporated herein by reference.

### FIELD

The embodiments discussed herein are related to a service-linkage control program and the like.

### BACKGROUND

In recent years, a service linkage tool called If This Then That (IFTTT) has been known as a tool for linking two or more services. The basic operation of a service linkage tool is to trigger an action in another service based on an event occurring in a certain service (for example, refer to Japanese Laid-open Patent Publication No. 2017-045098).

However, some services do not have any event that can be used as a trigger. In such a case, there is a problem in that it is difficult for a service linkage tool to operate in such a way that an event occurring in one service is used as a trigger to cause an action in another service.

To address this problem, when linking with a service that does not have an event that can be used as a trigger, the service needs to be modified. However, in the case of cloud services, modifications to the service are not possible.

Alternatively, instead of using events, it is possible to transition to another service by checking an execution state of the operating service. However, for services without a process ID or services that can be executed under the same name, it is difficult to identify an execution state to be checked (Japanese Laid-open Patent Publication Nos. 2008-123221, 2011-118587, 2008-276577).

### SUMMARY

According to an aspect of an embodiment, a non-transitory computer-readable recording medium stores therein a service-linkage control program that causes a computer to execute a process including determining whether a monitoring condition in which a condition for monitoring a monitoring target that operates on a service is set is defined in a job flow using a plurality of services, monitoring a service based on the monitoring condition when it is determined that the monitoring condition is defined in the job flow, and transitioning, when a transition condition in which a condition for the service to transition to a next service is set is satisfied as a result of the monitoring, the service to the next service based on the job flow.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a flow of a service linkage control according to an embodiment;

FIG. 2 is a diagram illustrating an example of a functional configuration of a service-linkage control system according to an embodiment;

FIG. 3 is a diagram illustrating an example of a configuration of a job network definition according to the embodiment;

FIG. 4 is a diagram illustrating an example of a configuration of a connection information definition according to the embodiment;

FIG. 5 is a diagram illustrating an example of a configuration of a monitoring condition definition according to the embodiment;

FIG. 6 is a diagram illustrating an example of a configuration of a transition condition definition according to the embodiment;

FIG. 7 is a diagram illustrating an example of a configuration of a monitoring history according to the embodiment;

FIG. 8 is a diagram illustrating an example of a configuration of service information according to the embodiment;

FIG. 9 is a diagram illustrating an example of a monitoring process according to an embodiment;

FIG. 10 is a diagram illustrating an example of a transition determination process according to the embodiment;

FIG. 11 is a diagram illustrating another example of the transition determination process according to the embodiment;

FIG. 12 is a diagram illustrating still another example of the transition determination process according to the embodiment;

FIG. 13 is a diagram illustrating an example of a flowchart of an activation process according to the embodiment;

FIG. 14 is a diagram illustrating an example of a flowchart of monitoring process processing according to the embodiment;

FIG. 15 is a diagram illustrating an example of a flowchart of a request generation process according to the embodiment;

FIG. 16 is a diagram illustrating an example of a flowchart of a monitoring-time-range determination process;

FIG. 17 is a diagram illustrating an example of a flowchart of the monitoring process according to the embodiment;

FIG. 18 is a diagram illustrating an example of a flowchart of the transition determination process according to the embodiment;

FIG. 19 is a diagram illustrating an example of an effect of the service linkage control according to the embodiment;

FIG. 20 is a diagram illustrating an example of a computer that executes a service-linkage control program;

FIG. 21 is a reference diagram illustrating a usage scenario of the service linkage;

FIG. 22A is a reference diagram 1 illustrating a control method of the service linkage;

FIG. 22B is a reference diagram 2 illustrating a control method of the service linkage;

FIG. 22C is a reference diagram 3 illustrating a control method of the service linkage; and

FIG. 22D is a reference diagram 4 illustrating a control method of the service linkage.

### DESCRIPTION OF EMBODIMENT(S)

Preferred embodiments will be explained with reference to accompanying drawings. The present invention is not limited to the embodiments.

### Reference Example of Usage Scenario of Service Linkage

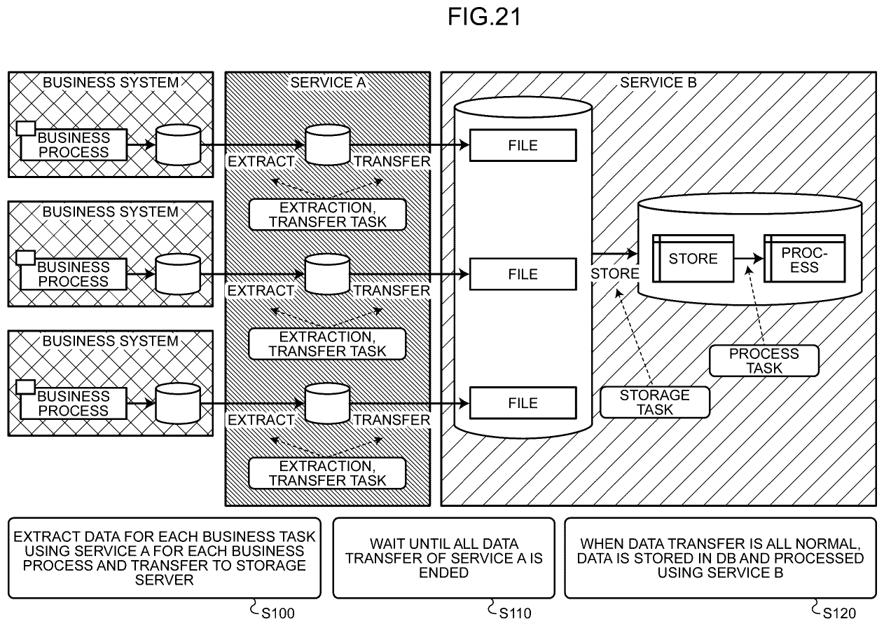

First, a usage scenario of linking multiple services will be explained. FIG. 21 is a reference diagram illustrating a usage scenario of service linkage. As illustrated in FIG. 21, in a usage scenario of the service linkage, for multiple businesses, only after all data transferred by specific services has been collected, processing is performed by another service using the latest data.

For example, the usage scenario illustrated in FIG. 21 is a usage scenario in which linkage of a service A that extracts and transfers data and a service B that stores and processes data is performed. Multiple business systems respectively perform respective business processes. The business processes respectively executed by the multiple business systems may be the same business task. Each of the business systems uses the service A for each business process, extracts data for each business task, to transfer to a storage server that executes the service B (S100). The processing of extracting and transferring data is executed by an extraction/transfer task.

The service B waits until all data transfers are completed (S110).

In the service B, when all data transfers are successful, data is stored in a database (DB) and processed using the service B (S120). The process of storing data in the DB is executed by a storage task. The process of processing data is executed by a processing task. In actual situation, it is impossible to determine whether data transfer is completed in the service B. Therefore, the storage task and the processing task are executed based on a schedule. Moreover, the storage task and the processing task are manually operated.

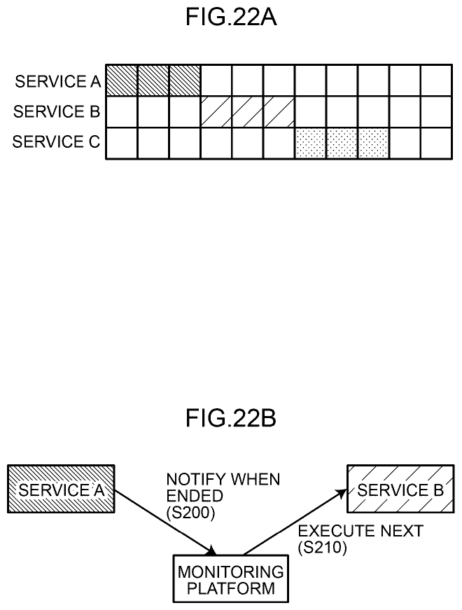

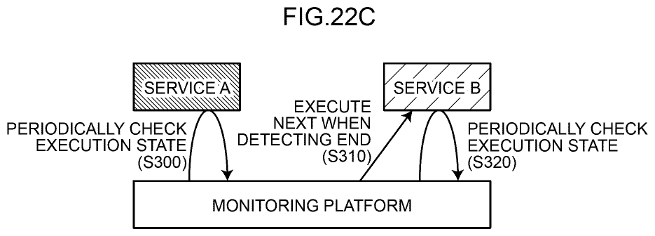

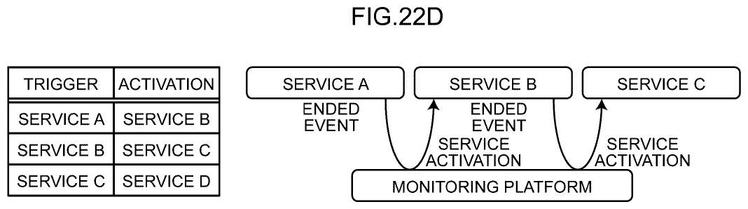

The control of linking multiple different services includes, in addition to scheduled execution and manual operation, a method of notifying upon completion of a service, a method of monitoring a state of a service, and the like. FIG. 22A to FIG. 22D are reference diagrams illustrating a con troll method of the service linkage.

FIG. 22A illustrates a case of scheduled execution as the control method of service linkage. As illustrated in FIG. 22A, in the scheduled execution, a schedule for each service is defined in advance, and a defined service is performed at a defined start time. However, in the scheduled execution, if the execution time of a preceding service is extended, a subsequent service starts execution before the preceding service completes processing. Thus, in the usage scenario described above, it becomes impossible to perform processing with the latest data after all data to be transferred is gathered.

FIG. 22B illustrates a case of notifying upon completion of a service as a control method of service linkage. As illustrated in FIG. 22B, in the method of notifying upon completion of a service, the service A notifies of completion of the service at the time when the service is terminated (S200). A monitoring platform that has received the notification executes the next service B (S210). In the method of notifying upon completion of a service, if there is no event indicating the completing of the service, such an event needs to be added to the service. However, in the case of cloud services, such as Saas, it is not possible to modify the service.

FIG. 22C illustrates a case in which a state of a service is periodically monitored as a control method of service linkage. As illustrated in FIG. 22C, in the method of monitoring a state of a service, a monitoring platform periodically monitors an execution state of the service A (S300). Upon detection of completion, the monitoring platform executes the next service B (S310). Subsequently, the monitoring platform periodically checks the execution state of the service B (S320). However, for services without a process ID or services that can be executed under the same task name, it is difficult to identify the execution state to be checked.

FIG. 22D illustrates a case in which a control method of service linkage applies a service linkage tool called IFTTT. The basic operation of the service linkage tool is to trigger an action for another service based on an event occurring in one service. As illustrated in FIG. 22D, for example, the service linkage tool defines pairs of a service to be a trigger and a service to be activated. The monitoring platform then transitions the service according to the definition. As an example, the monitoring platform activates the service B based on a completion event of the service A as a trigger according to the definition. The monitoring platform activates the service C based on a completion event of the service B as a trigger according to the definition. However, when a service linkage tool is applied, it is assumed that the service has an event that can be used as a trigger. If there is no event that can be used as a trigger in the service, such an event needs to be added to the service. However, in the case of cloud services, such as Saas, it is not possible to modify the service.

As described, in the control method of service linkage, there is a problem that achieving service linkage without modifying services is difficult. Therefore, in the following embodiments, a service linkage control that enables service linkage without modifying a service will be explained.

### Flow of Service Linkage Control

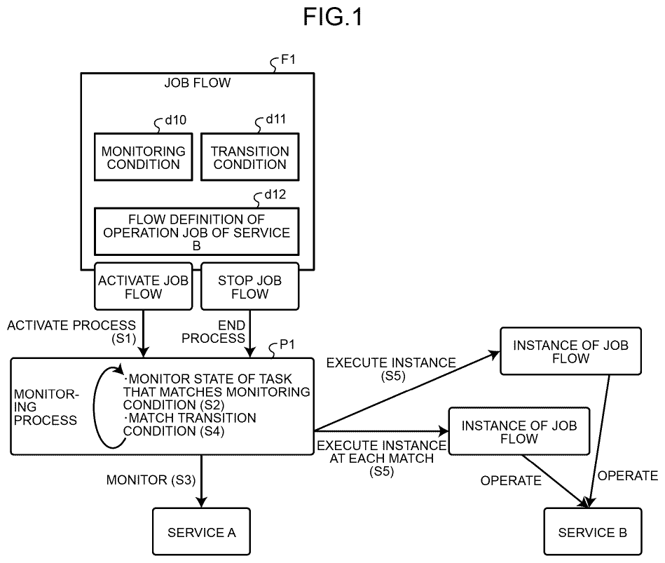

FIG. 1 is a diagram illustrating an example of a flow of a service linkage control according to an embodiment. As illustrated in FIG. 1, a job flow F1 for a task using multiple services A, B is defined. The job flow F1 is information that defines execution sequence of tasks for a job (business). For example, a job flow of a usage scenario in which multiple services are linked illustrated in FIG. 21 is defined that an extraction/transfer task is executed as an operation of the service A, and a storage task and then a processing task are executed in this order as operations of the service B. The job flow F1 may be generated separately for each system when multiple systems perform the same task, or it may be generated integrating tasks of multiple systems into a single definition. Moreover, hereinafter, the job flow F1 may be referred to as “job network”.

In the job flow F1, as a definition for monitoring a task in a service, a monitoring condition d10 and a transition condition d11 are defined. The monitoring condition d10 is, for example, a condition for monitoring a monitoring target operating on the service A. In the monitoring condition d10, as the monitoring target, a condition to be monitored, such as a task, is defined. The transition condition d2 is a condition for transitioning to the next service B. In the transition condition d2, a condition for transitioning, such as an expected task completion period and a condition for a case in which multiple monitoring targets apply, is defined. The condition for the case in which multiple monitoring targets apply includes, for example, when more than one task to be monitored is present. For the transition condition for such a case, for example, all multiple relevant monitoring targets being in normal status, all multiple relevant monitoring targets having completed regardless of its status being normal or abnormal, and at least one of multiple relevant monitoring targets having completed normally. Detailed explanation of the monitoring condition d10 and the transition condition d11 will be described later.

In the service-linkage control process, upon accepting an activation of the job flow F1, a monitoring process P1 is started when the monitoring condition d10 is defined (S1). When the monitoring condition d10 is not defined, the service-linkage control process may perform execution processing of a conventional job flow.

The monitoring process P1 monitors a state of a task that matches the monitoring condition d11 (S2, S3). For example, the monitoring process P1 acquires task information indicating states of multiple tasks from the service A. The monitoring process P1 identifies a task that matches the monitoring target included in the monitoring condition d11. The monitoring process P1 uses the task information to monitor the state of the identified task.

The monitoring process P1 then determines whether the service matches the transition condition d11 (S4). When the service matches the transition condition d11, the monitoring process P1 transitions the service A that has been being monitored currently according to the job flow F1 to the next service B. That is, the monitoring process P1 executes a process instance of the job flow F1 (S5). For example, suppose that the transition condition d11 is a condition that all of multiple relevant monitoring targets are normal. When multiple tasks of the monitoring target defined in the monitoring condition d10 apply, the monitoring process P1 executes the process instance of the job flow F1 to transition to the next service B following the service A upon completion of all of the multiple relevant tasks. As an example, when multiple tasks a of the relevant monitoring target are being executed, when all of these tasks a are normally completed, the monitoring process P1 transitions to the next service B following the service A. That is, in the case of the use scenario illustrated in FIG. 21, after all of multiple data to be transferred by the extraction/transfer task in the service A have been collected, multiple processing tasks in the service B can be executed.

In the transition condition, an action after execution of the instance is specified by a user. The action after execution of the instance includes an action of waiting execution of a next monitoring target, and an action of terminating the monitoring process P1. The monitoring process P1 performs the action after execution of the instance in accordance with the specification.

Thus, the service-linkage control process enables linkage of services without modifying a service, by using the monitoring condition and the transition condition for the service linkage control.

### Functional Configuration of Service-Linkage Control System

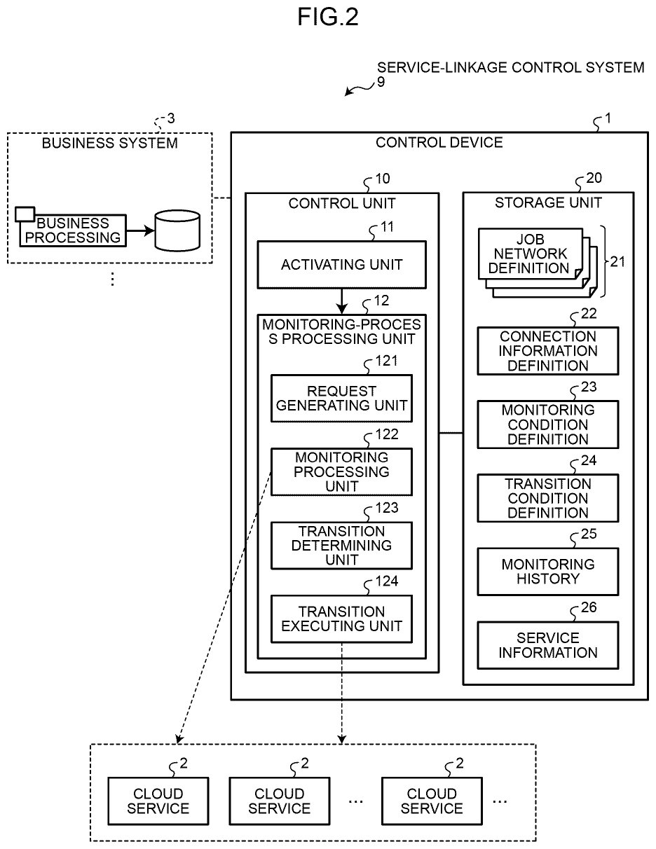

FIG. 2 is a diagram illustrating an example of a functional configuration of the service-linkage control system according to the embodiment. As illustrated in FIG. 2, a service-linkage control system 9 includes a control device 1, multiple cloud services 2, and a business system 3.

The cloud service 2 is, for example, a service that allows use of software on the cloud via the Internet, that is, SaaS. The cloud service 2 corresponds to the services A and B illustrated in FIG. 1.

The business system 3 executes a business task using the multiple cloud services 2 using a job network registered in the control device 1. Although only one business system 3 is illustrated, multiple business systems 3 may be present.

The control device 1 includes a control unit 10 and a storage unit 20. The control unit 10 includes an activating unit 11 and a monitoring-process processing unit 12. The storage unit 20 includes a job network definition 21, a connection information definition 22, a monitoring condition definition 23, a transition condition definition 24, a monitoring history 25, and service information 26.

The job network definition 21 is information in which execution order is defined for jobs (business tasks). The job network definition 21 is synonymous with job flow. When the same business task is executed by multiple business systems, the job network definition 21 may be created for each of the multiple business systems, or may be created, integrating the respective business tasks of the business systems into a single definition. The job network definition 21 is defined in advance by a user.

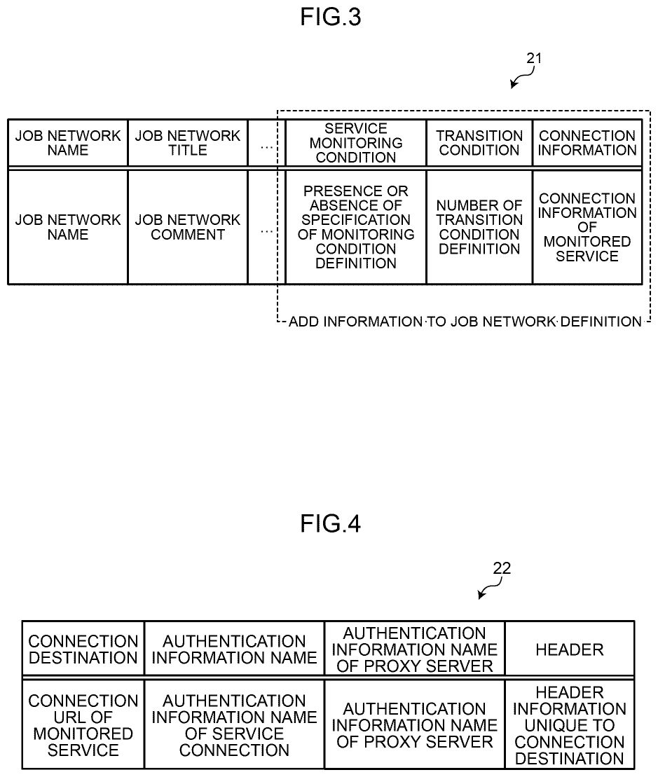

A configuration of the job network definition 21 will be explained, referring to FIG. 3. FIG. 3 is a diagram illustrating an example of a configuration of the job network definition according to the embodiment. As illustrated in FIG. 3, the job network definition 21 stores a job network name, a service monitoring condition, a transition condition, and connection information associating with one another. The job network name is information indicating a name of a job network of each job network. The service monitoring condition is information indicating whether there is a specification of the monitoring condition definition 23. When there is a specification, a definition ID stored in the monitoring condition definition 23 is set for the service monitoring condition. For the transition condition, a definition ID stored in the transition condition definition 24 is set. The connection information is associated with the connection information definition 22 of a service to be monitored. The transition condition and the connection information are set when there is a specification in the service monitoring condition.

Referring back to FIG. 2, the connection information definition 22 is information in which the connection information to connect to a service to be monitored is defined. Information indicated by the connection information definition 22 is associated with connection information of the job network definition 21. The connection information definition 22 is defined in advance by a user.

A configuration of the connection information definition 22 will be explained referring to FIG. 4. FIG. 4 is a diagram illustrating an example of a configuration of the connection information definition according to the embodiment. As illustrated in FIG. 4, the connection information definition 22 stores a connection destination, an authentication information name, an authentication information name of a proxy server, and a header, associating with one another. The connection destination is information indicating a connection uniform resource locator (URL) of a service to be monitored. The authentication information name is information indicating an authentication information name of connection to a service. The authentication information name of a proxy server is information indicating an authentication information name of a proxy server. The header is header information unique to a connection destination.

Referring back to FIG. 2, the monitoring condition definition 23 is information in which a monitoring condition for monitoring a service is defined.

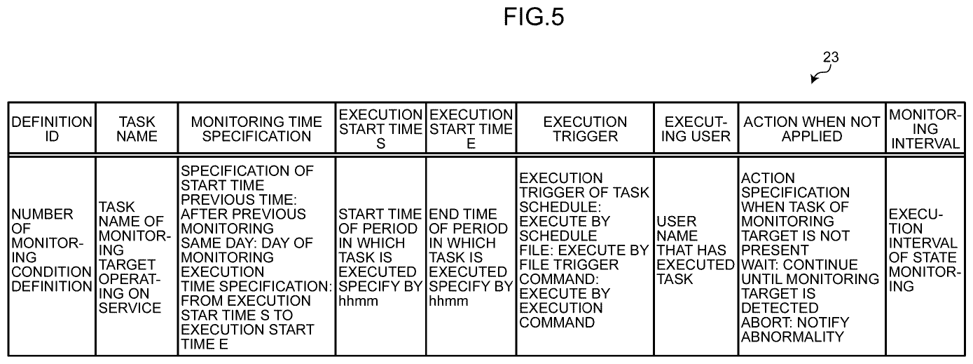

A configuration of the monitoring condition definition 23 will be explained referring to FIG. 5. FIG. 5 is a diagram illustrating an example of a configuration of the monitoring condition definition according to the embodiment. As illustrated in FIG. 5, the monitoring condition definition 23 stores a definition ID, a task name, a monitoring time specification, an execution start time S, an execution start time E, an execution trigger, an executing user, an action when not applicable, and a monitoring interval, associating with one another.

The definition ID indicates a number that uniquely represents the monitoring condition. The task name is a name of a task of the monitoring target operating on a service. The monitoring time specification is information specifying a start time for monitoring. For the monitoring time specification, for example, either one of “previous time”, “same day”, and “specified time” is set. “Previous time” is set when monitoring from the point after the monitoring at the previous execution is performed. “Previous time” is a default setting value. “Same day” is set when an execution date of monitoring is specified. When the monitoring condition is used for the first time, or when there has been a time gap since the previous use, “same day” is set. “Specified time” is set when a time to start monitoring is specified.

The execution start time S is a start time of a period in which a task is executed, and is expressed by hhmm. hh represents hours, and mm represents minutes. The execution start time E is an end time of a period in which a task is executed, and is expressed by hhmm. The execution start time S and the execution start time E are used when the monitoring time specification is “specified time”.

The execution trigger is information indicating an execution trigger of a task. For the execution trigger, either one of execution by schedule, execution by a file trigger, and execution by a command is set as an example. The executing user is information indicating a user that executes a task.

The action when not applicable is information in which an action when a task of a monitoring target is not present is specified. For the action when not applicable, either one of WAIT and ABORT is set as an example. WAIT is set when it is to be continued until a monitoring target is detected. ABORT is set when an abnormality is notified. The monitoring interval is information indicating execution intervals of the state monitoring.

Referring back to FIG. 2, the transition condition definition 24 is information in which a transition condition to transit to a next service is defined.

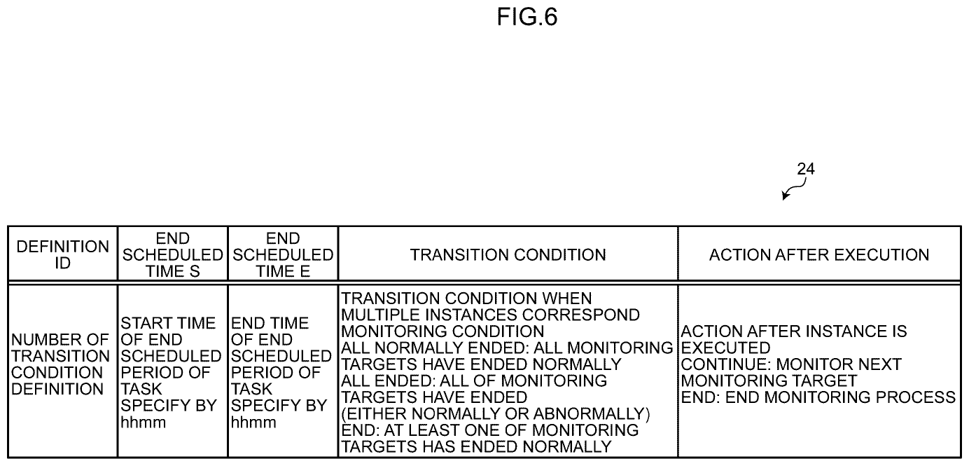

A configuration of the transition condition definition 24 will be explained referring to FIG. 6. FIG. 6 is a diagram illustrating an example of a configuration of the transition condition definition according to the embodiment. As illustrated in FIG. 6, the transition condition definition 24 stores a definition ID, an end scheduled time S, an end scheduled time E, a transition condition, and an action after execution, associating with one another.

The definition ID indicates a number that uniquely represents the transition condition. The end scheduled time S and the end scheduled time E indicate a range of an end scheduled time of a task of the monitoring target. The end scheduled time S is a start time of the range of an end scheduled time, and is expressed by hhmm. hh represents hours, and mm represents minutes. The end scheduled time E is an end time of a range of the end scheduled time, and is expressed by hhmm. The transition condition is a transition condition when multiple monitoring conditions apply.

For the transition condition, either one of all normally ended, all ended, and ended is set as an example, All normally ended means that when multiple relevant monitoring targets are all normally ended, an instance is performed. Performing an instance indicates transition to a next service. All ended means that when multiple relevant monitoring targets end either normally or abnormally, an instance is performed. Ended means that when at least either one of multiple relevant monitoring targets ends normally, an instance is performed.

The action after execution indicates an action after an instance is performed. For the action after execution, either one of “continue” and “end” is set as an example. “Continue” means that a next monitoring target is monitored. When the action after execution is “continue”, a task that has been used as the transition condition when the instance is performed is excluded from the next monitoring target. “End” means that the monitoring process is ended.

Referring back to FIG. 2, the monitoring history 25 stores a history of monitoring for the job network.

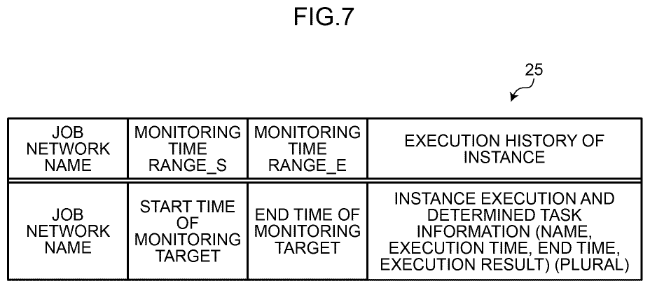

A configuration of the monitoring history 25 will be explained referring to FIG. 7. FIG. 7 is a diagram illustrating an example of a configuration of the monitoring history according to the embodiment. As illustrated in FIG. 7, the monitoring history 25 stores a job network name, a monitoring time range S, a monitoring time range_E, and an instance execution history, associating with one another. The job network name is information indicating a name of a job network. The job network name corresponds to the job network name of the job network definition 21. The monitoring time range S is a start time of monitoring of a monitoring target. The monitoring time range_E is an end time of monitoring of a monitoring target. For the instance execution history, task information of a monitoring target that has been determined to executes an instance is set. The task information includes a task name, an execution time of task monitoring, an end time of task monitoring, and an execution result.

Referring back to FIG. 2, the service information 26 stores information regarding a service. Because specification method to acquire information of a task and available information differ for each service, the service information 26 stores information regarding a specification method and available information that differ for each service, and the like.

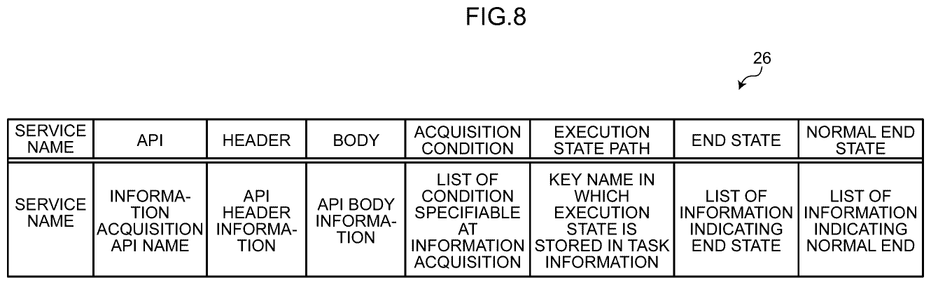

A configuration of the service information 26 will be explained referring to FIG. 8. FIG. 8 is a diagram illustrating an example of a configuration of the service information according to the embodiment. As illustrated in FIG. 8, the service information 26 stores a service name, an application programming interface (API), a header, a body, an acquisition condition, an execution state path, an end state, and a normal end state, associating with one another.

The service name is a name to uniquely identify a service. The API is a name of API used to acquire task information. The header indicates header information of the API. The body indicates body information of the API. The acquisition condition indicates a list of conditions that can be specified at the time of acquiring the task information. The execution state path indicates a key (path) name in which an execution state is stored in the task information. The end state indicates a list of information representing an end state. The normal end state indicates a list of information representing normal end.

Referring back to FIG. 2, the control unit 10 includes the activating unit 11 and the monitoring-process processing unit 12.

The activating unit 11 activates a target job network. For example, upon accepting an execution request of a target job network, the activating unit 11 reads the job network definition 21 from the storage unit 20. The activating unit 11 then determined whether there is a specification for the monitoring condition definition 23 in a service monitoring condition item of the read job network definition 21. That is, the activating unit 11 determines whether a monitoring condition to monitor a monitoring target that operates on the service is defined in a job flow using multiple services. When it is determined that there is a specification for the monitoring condition definition 23, the activating unit 11 activates a monitoring process to monitor the monitoring target defined in the monitoring condition definition 23. When it is determined that there is no specification for the monitoring condition definition 23, the activating unit 11 executes a conventional job network.

The monitoring-process processing unit 12 processes the monitoring process. The monitoring-process processing unit 12 includes a request generating unit 121, a monitoring processing unit 122, a transition determining unit 123, and a transition executing unit 124.

The request generating unit 121 generates a request (task-information acquisition request) to acquire information of a task to be monitored.

For example, the request generating unit 121 loads a connection information item defined in the job network definition 21, a service monitoring condition item, the connection information definition 22 associated respectively with the transition condition item, the monitoring condition definition 23, and the transition condition definition 24. The request generating unit 121 identifies a target service from settings of the connection destination and the header defined in the connection information definition 22. The request generating unit 121 acquires information for information acquisition for an identified service from service information 26. The information for information acquisition includes, for example, information of the API (specified parameters, specification method) and the like used to acquire information. That is, the information for information acquisition is information regarding a specification method and available information that differ for each service and the like.

Moreover, the request generating unit 121 refers to the monitoring history 25, and acquires previous monitoring information corresponding to the target job network. In the previous monitoring information, the monitoring time range during monitoring processing and the history when the instance has been executed. The request generating unit 121 calculates the monitoring time range to be set for the information acquisition request of a task from the previous monitoring information acquired from the monitoring history 25, the monitoring condition definition 23, and the transition condition definition 24.

As an example, the request generating unit 121 calculates the monitoring time range as follows by using the previous monitoring information acquired from the monitoring history 25 when the monitoring time specification item set in the monitoring condition definition 23 is “previous time” or “not specified”. When there is no previous monitoring information (when the monitoring condition is being used for the first time), or when the end time of the previous monitoring target is more than three days ago (when there has been long since the previous use), “from start time of a business task” is calculated as the monitoring time range. This is because monitoring has never been performed since the start of the business task. Moreover, when previous monitoring information is present and the end time of the previous monitoring target is not more than three days ago, “from end time of previous monitoring (the monitoring time range_E)” is calculated as the monitoring time range. The monitoring time range_E is set in the previous monitoring information acquired from the monitoring history 25. This is to avoid monitoring of the same time period. Although the boundary value for the end time of the previous monitoring target is set to three days, it is not limited thereto. It may be set to two days or four days, as long as it is predefined.

As another example, the request generating unit 121 calculates the monitoring time range as follows by using the previous monitoring information acquired from the monitoring history 25 and the transition condition definition 24 when the monitoring time specification item set in the monitoring condition definition 23 is “same day”. When there is no previous monitoring information, “from start time of a business task” is calculated as the monitoring time range. This is because monitoring is not performed on the same day. When previous monitoring information is present and when the end time of the previous monitoring target is later than the start time of the business task, if there is an execution history of an instance and the transition condition in the transition condition definition 24 is “all normally ended” or “all ended”, “from end time of previous monitoring (monitoring time range_E)” is calculated to target the period after the previous monitoring time as the monitoring time range after instance execution. This is to avoid monitoring of the same time period. For example, when it is ended with the monitoring time range “0:00 to 2:30” at the first execution, the monitoring time range for the second execution is set to “from 2:31”.

Furthermore, when previous monitoring information is present and when the end time of the previous monitoring target is later than the start time of the business task, if there is an execution history of an instance and the transition condition in the transition condition definition 24 is “at least one ended”, “from start time of previous monitoring (monitoring time range S)” is calculated to target the start time same as the previous time as the monitoring time range.

Moreover, when previous monitoring information is present and when the end time of the previous monitoring target is before the start time of the business task, “from start time of the business task” is calculated as the previous time as the monitoring time range. This is because monitoring has never been performed since the start of this business task.

As another example, the request generating unit 121 calculates the monitoring time range by using the execution start time S and the execution start time E when the monitoring time specification item set in the monitoring condition definition 23 is “specified time”. That is, “execution start time S to execution start time E” is calculated as the monitoring time range. This is to ensure that monitoring is performed only for the time specified in the monitoring condition.

The request generating unit 121 generates an information acquisition request of a task to be monitored by setting the information for information acquisition of a service and the calculated monitoring time range.

The monitoring processing unit 122 monitors a service based on the monitoring condition.

For example, the monitoring processing unit 122 executes an information acquisition request of a task generated by the request generating unit 121 to the target service. The monitoring processing unit 122 acquires task information from the target service, and extracts information of a task that matches the monitoring condition. As an example, the monitoring processing unit 122 refers to the task name, the execution start time S, the execution start time E, the execution trigger, and the executing user defined in the monitoring condition definition 23, and extracts information of a task that matches the monitoring condition from the task information corresponding to the target service. Because the acquiring method of information needed for the target service differs according to a service, it may be acquired by using the acquisition condition and the execution state path defined in the service information 26.

The monitoring processing unit 122 shifts to the transition determining unit 123 when the information of the task to be monitored is extracted. Moreover, when the information of the task to be monitored is not extracted, the monitoring processing unit 122 performs processing according to contents set to the action specification item for the case in which the monitoring condition definition 23 is not applicable. As an example, when the action specification item is WAIT (continue until a monitoring target is detected), the monitoring processing unit 122 shifts to the request generating unit 121 to reset the information acquisition request of a task. When the action specification item is ABORT (abnormality notification), the monitoring processing unit 122 notifies error information.

The transition determining unit 123 determines whether to transition to a next service based on the transition condition. For example, the transition determining unit 123 extracts an execution state and an execution result of a task from the information of a task to be monitored extracted by the monitoring processing unit 122. The transition determining unit 123 determines whether to match the transition condition set in the transition condition item in the transition condition definition 24 using the execution state and the execution result of the extracted task. When the task matches the transition condition, the transition determining unit 123 stores the task information of the task in the monitoring history 25 as the previous monitoring information, and transitions to the transition executing unit 124 to transition to the next service. Moreover, when it does not match the transition condition and it has not exceeded the end scheduled time set in the transition condition definition 24, the transition determining unit 123 continues monitoring of the task after waiting for a monitoring interval set in the monitoring condition definition 23. Furthermore, the transition determining unit 123 notifies error information when it does not match the transition condition and it has exceeded the scheduled end time set in the transition condition definition 24.

The transition executing unit 124 executes a process instance of a job network to transition to the next service. For example, the transition executing unit 124 generates an instance to perform the job network for which specification of the monitoring condition definition 23 is included in the service monitoring condition item in the job network definition 21. The transition executing unit 124 executes the generated instance.

### One Example of Monitoring Processing

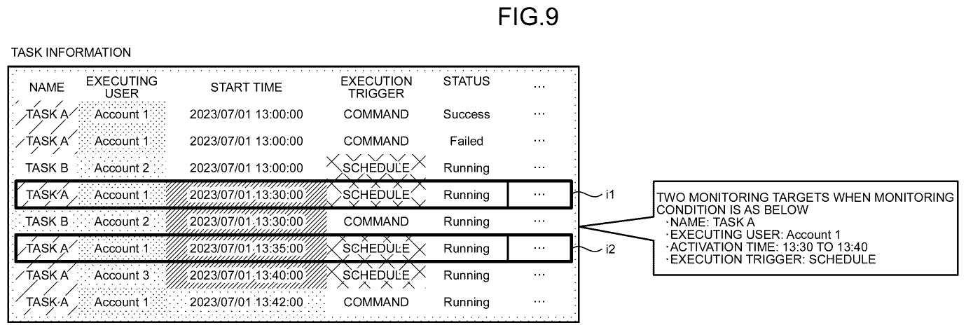

An example of the monitoring processing performed by the monitoring processing unit 122 will be explained referring to FIG. 9. FIG. 9 is a diagram illustrating an example of the monitoring processing according to the embodiment. FIG. 9 illustrates information of a task acquired from a target service. That is, the monitoring processing unit 122 performs the information acquisition request of a task with respect to the target service, and acquires task information of the target service. The task information acquisition request varies for each service. The format of the acquired task information varies for each service.

In the example in FIG. 9, the monitoring condition defined in the monitoring condition definition 23 is “task A” as the task name, “Account1” as the executing user, “13:30 to 13:40” as the period in which the task is executed (the activation time), and “schedule” as the execution trigger. Under these conditions, the monitoring processing unit 122 extracts information of a task that matches the monitoring condition from the task information. The task indicated by the extracted information of a task is a monitoring target. The monitoring target herein is two instances of “task A” represented by symbols i1, i2. One example of Transition Determination

### Processing

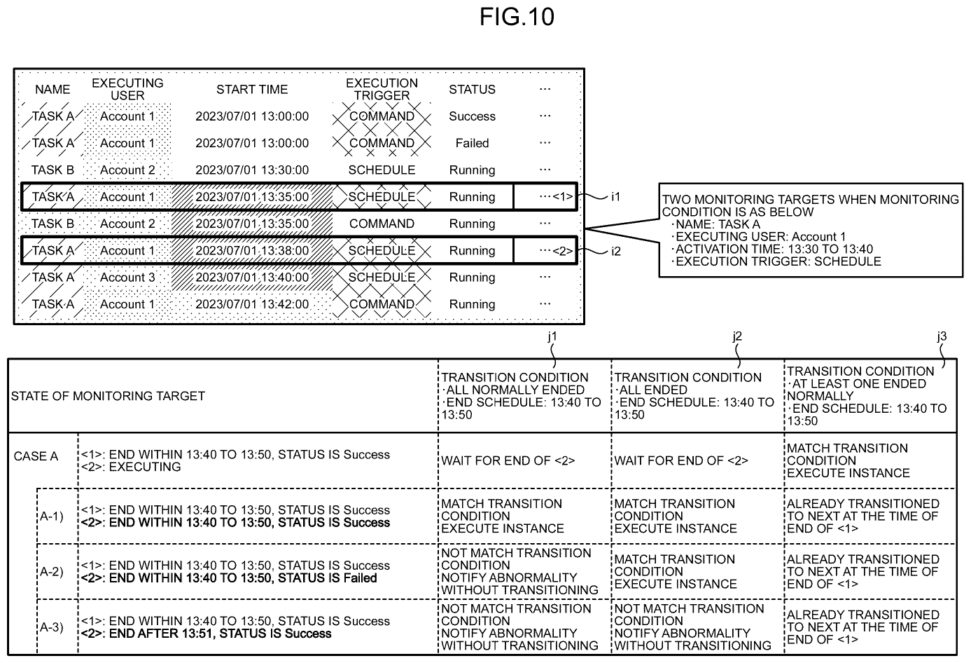

An example of the transition determination processing performed by the transition determining unit 123 will be explained referring to FIG. 10. FIG. 10 is a diagram illustrating an example of the transition determination processing according to the embodiment. The monitoring target is two instances of “task A” illustrated in FIG. 9. For convenience, the task A represented by the symbol i1 is referred to as <1> and the task A represented by the symbol i2 is referred to as <2>, to be distinguished from each other.

Under such a condition, the transition determining unit 123 extracts an execution state and an execution result of the task from the information of a task of the monitoring target. The transition determining unit 123 then determines whether it matches the transition condition set in the transition condition item in the transition condition definition 24 by using the extracted execution state and execution result (status) of the task.

In the example illustrated in FIG. 10, suppose that a transition j1 defined by the transition condition definition 24 is “all normally ended” as the transition condition, and “13:40 to 13:50” as the end scheduled time, set in the transition condition item. “All normally ended” indicates that all of the monitoring targets are in a normal state. Suppose that a transition condition j2 is “all ended” as the transition condition, and “13:40 to 13:50” as the end scheduled time, set in the transition condition item. “All ended” indicates that all of the monitoring targets are ended. Suppose that a transition condition j3 is “ended” as the transition condition, and “13:40 to 13:50” as the end scheduled time, set in the transition condition item. “Ended” indicates that at least either one of the monitoring targets is normally ended.

First, the transition determination process will be explained when the transition condition is the symbol j1. In Case A, the execution state of the monitoring target<1> is turned into “ended” during a period of “13:40 to 13:50”, and the status becomes “Success” (normal). Suppose that the execution state of the monitoring target<2> is “executing”. In this case, because the monitoring target<2> is being executed, it does not match the transition condition j1 that all instances have been normally completed within “13:40 to 13:50”, and the transition determining unit 123 waits until an end of the monitoring target<2>.

Suppose that time has passed since the state of Case A, and the execution state of the monitoring target<2>becomes “ended” during the period of “13:40 to 13:50” and the status becomes “Success” in Case A-1. In this case, the transition determining unit 123 determines it matches the transition condition j1 because the monitoring target<1> and the monitoring target<2>have ended normally within the end scheduled period. The transition determining unit 123 shifts to the transition executing unit 124. The transition executing unit 124 executes a process instance of the job network to transition to the next service.

Moreover, suppose that time has passed since the state of Case A, and the execution state of the monitoring target<2>becomes “ended” during the period of “13:40 to 13:50” and the status becomes “Failed” in Case A-2. In this case, the transition determining unit 123 determines it does not match the transition condition j1 because the monitoring target<2>does not end normally within the end scheduled period. The transition determining unit 123 notifies abnormality without transitioning to the next service.

Furthermore, in case A-3, suppose that time has passed since the state of Case A, and the execution state of the monitoring target<2>becomes “ended” after “13:51” and the status becomes “Success”. In this case, the transition determining unit 123 determines it does not match the transition condition j1 because the monitoring target<1> and the monitoring target<2>ended normally but it has exceeded the end scheduled period. The transition determining unit 123 notifies an abnormality without transitioning to the next service.

Next, the transition determination process when the transition condition is the symbol j2 will be explained. In Case A, the execution state of the monitoring target<1>becomes “ended” and the status becomes “Success”. Suppose that the execution state of the monitoring target<2> is “executing”. In this case, because the monitoring target<2> is being executed, it does not match the transition condition j2 in which all instances are ended within “13:40 to 13:50”, and the transition determining unit 123 waits until an end of the monitoring target<2>.

Suppose that time has passed since the state of Case A, and the execution state of the monitoring target<2>becomes “ended” during the period of “13:40 to 13:50” and the status becomes “Success” in Case A-1. In this case, the transition determining unit 123 determines it matches the transition condition j2 because the monitoring target<1> and the monitoring target<2>have ended within the end scheduled period. The transition determining unit 123 shifts to the transition executing unit 124. The transition executing unit 124 executes a process instance of the job network to transition to the next service.

Moreover, suppose that time has passed since the state of Case A, and the execution state of the monitoring target<2>becomes “ended” during the period of “13:40 to 13:50” and the status becomes “Failed” in Case A-2. In this case, the transition determining unit 123 determines it matches the transition condition j2 because the monitoring target<1> and the monitoring target<2>have ended within the end scheduled period. The transition determining unit 123 shifts to the transition executing unit 124. The transition executing unit 124 executes a process instance of a job network to transition to the next service.

Moreover, suppose that time has passed since the state of Case A, and the execution state of the monitoring target<2>becomes “ended” after “13:51” and the status becomes “Success” in Case A-3. In this case, the transition determining unit 123 determines it does not match the transition condition j2 because the monitoring target<2>has ended but it has exceeded the end scheduled period. The transition determining unit 123 notifies abnormality without transitioning to the next service.

Next, the transition determination process when the transition condition is the symbol j3 will be explained. In Case A, the execution state of the monitoring target<1>becomes “ended” during the period of “13:40 to 13:50” and the status becomes “Success”. Suppose that the execution state of the monitoring target<2> is “executing”. In this case, because the monitoring target<1>has normally ended within “13:40 to 13:50”, the transition determining unit 123 determines that it matches the transition condition j3. The transition determining unit 123 shifts to the transition executing unit 124. The transition executing unit 124 executes a process instance of a job network to transition to the next service.

Because it has transitioned to the next service at the time when the monitoring target<1>ends in Case A-1, Case A-2, and Case A-3 that occur after time has passed from the state of Case A has ended and, therefore, nothing is processed by the transition determining unit 123.

### Another Example of Transition Determination Process

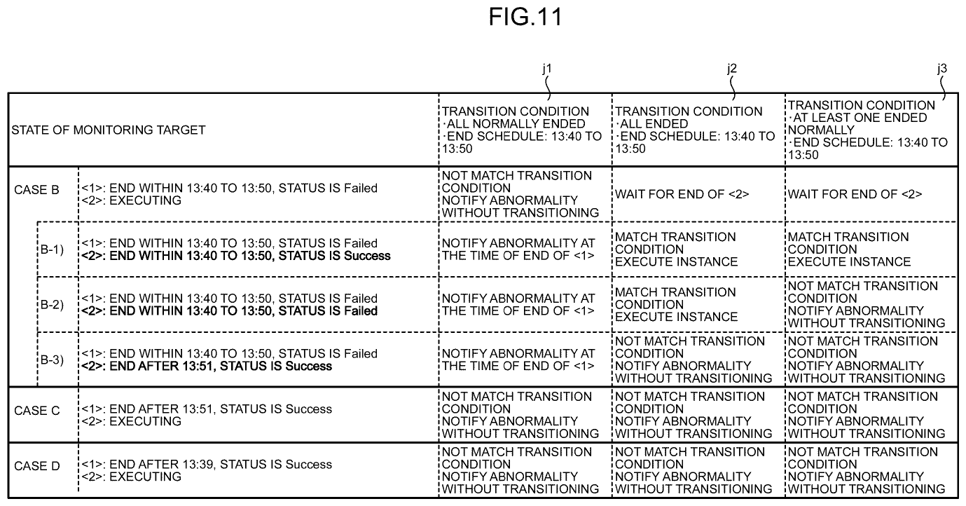

Next, another example of the transition determination process performed by the transition determining unit 123 will be explained referring to FIG. 11. FIG. 11 is a diagram illustrating another example of the transition determination process according to the embodiment. Suppose that the monitoring target is two instances of “task A” illustrated in FIG. 9 similarly to the case of FIG. 10. In this example also, the task A represented by the symbol i1 is referred to as <1> and the task A represented by the symbol i2 is referred to as <2>, to be distinguished from each other.

Under such a condition, the transition determining unit 123 extracts an execution state and an execution result of the task from the information of a task of the monitoring target. The transition determining unit 123 then determines whether it matches the transition condition set in the transition condition item in the transition condition definition 24 by using the extracted execution state and execution result (status) of the task.

In the example illustrated in FIG. 11, suppose that a transition condition j1 defined by the transition condition definition 24 is “all normally ended” as the transition condition, and “13:40 to 13:50” as the end scheduled time, similarly to the case of FIG. 10. “All normally ended” indicates that all of the monitoring targets are in a normal state. Suppose that a transition condition j2 is “all ended” as the transition condition, and “13:40 to 13:50” as the end scheduled time. “All ended” indicates that all of the monitoring targets are ended. Suppose that a transition condition j3 is “ended” as the transition condition, and “13:40 to 13:50” as the end scheduled time. “Ended” indicates that at least either one of the monitoring targets has normally ended.

First, the transition determination process will be explained when the transition condition is the symbol j1. In Case B, the execution state of the monitoring target<1> is turned into “ended” during a period of “13:40 to 13:50”, and the status becomes “Failed”. Suppose that the execution state of the monitoring target<2> is “executing”. In this case, because the end status of the monitoring target<1> is “Failed”, it does not match the transition condition j1 that all instances have been normally completed within “13:40 to 13:50”, and the transition determining unit 123 notifies an abnormality.

Because an abnormality is notified at the point of time when the monitoring target<1>ends in Case B-1, Case B-2, and Case B-3 that occur after time has passed from the state of Case B, nothing is processed by the transition determining unit 123.

Next, the transition determination process when the transition condition is the symbol j2 will be explained. In Case B, the execution state of the monitoring target<1>becomes “ended” during the period of “13:40 to 13:50” and the status becomes “Failed”. Suppose that the execution state of the monitoring target<2> is “executing”. In this case, because the monitoring target<2> is being executed, it does not match the transition condition j2 in which all instances are ended within “13:40 to 13:50”, and the transition determining unit 123 waits until an end of the monitoring target<2>.

Suppose that time has passed since the state of Case B, and the execution state of the monitoring target<2>becomes “ended” during the period of “13:40 to 13:50” and the status becomes “Success” in Case B-1. In this case, the transition determining unit 123 determines it matches the transition condition j2 because all of the monitoring targets have ended and the monitoring target<1> and the monitoring target<2>have ended within the end scheduled period. The transition determining unit 123 shifts to the transition executing unit 124. The transition executing unit 124 executes a process instance of the job network to transition to the next service.

Moreover, suppose that time has passed since the state of Case B, and the execution state of the monitoring target<2>becomes “ended” during the period of “13:40 to 13:50” and the status becomes “Failed” in Case B-2. In this case, the transition determining unit 123 determines it matches the transition condition j2 because the monitoring target<1> and the monitoring target<2>have ended within the end scheduled period although the status of the monitoring target<2> is “Failed”. The transition determining unit 123 shifts to the transition executing unit 124. The transition executing unit 124 executes a process instance of a job network to transition to the next service.

Moreover, suppose that time has passed since the state of Case B, and the execution state of the monitoring target<2>becomes “ended” after “13:51” and the status becomes “Success” in Case B-3. In this case, the transition determining unit 123 determines it does not match the transition condition j2 because the monitoring target<2>has ended but it has exceeded the end scheduled period. The transition determining unit 123 notifies abnormality without transitioning to the next service.

Next, the transition determination process when the transition condition is the symbol j3 will be explained. In Case B, the execution state of the monitoring target<1>becomes “ended” during the period of “13:40 to 13:50” and the status becomes “Failed”. Suppose that the execution state of the monitoring target<2> is “executing”. In this case, because the monitoring target<1> and the monitoring target<2>both have not ended normally, it does not match the transition condition j3 that is a condition that one has ended normally within “13:40 to 13:50”, and the transition determining unit 123 waits until an end of the monitoring target<2>.

Moreover, suppose that time has passed since the state of Case B, and the execution state of the monitoring target<2>becomes “ended” within “13:40 to 13:50” and the status becomes “Success” in Case B-1. In this case, the transition determining unit 123 determines it matches the transition condition j3 because one monitoring target has ended normally within the end scheduled period. The transition determining unit 123 shifts to the transition executing unit 124. The transition executing unit 124 executes a process instance to transition to the next service.

Moreover, suppose that time has passed since the state of Case B, and the execution state of the monitoring target<2>becomes “ended” during the period of “13:40 to 13:50” and the status becomes “Failed” in Case B-2. In this case, the transition determining unit 123 determines it does not match the transition condition j3 because all of the monitoring targets are “Failed”. The transition determining unit 123 notifies abnormality without transitioning to the next service.

Moreover, suppose that time has passed since the state of Case B, and the execution state of the monitoring target<2>becomes “ended” after “13:51” and the status becomes “Success” in Case B-3. In this case, the transition determining unit 123 determines it does not match the transition condition j3 because the end scheduled period has passed although the monitoring target<2>has ended normally. The transition determining unit 123 does not transition to the next service and notifies abnormality.

Next, the transition determination process when the transition condition of Case C is the symbol j1 will be explained. In Case C, the execution state of the monitoring target<1>becomes “ended” after “13:51”, and the status becomes “Success”. Suppose that the execution state of the monitoring target<2> is “executing”. In this case, the transition determining unit 123 determines it does not match the transition condition j1 because the end scheduled period has passed although the end status of the monitoring target<1> is “Success”. The transition determining unit 123 does not transition to the next service and notifies abnormality.

Furthermore, the transition determination process when the transition condition of Case C is the symbol j2 will be explained. In this case, the transition determining unit 123 determines that it does not match the transition condition j2 because the end schedule period has passed although the monitoring target<1>has ended. The transition determining unit 123 does not transition to the next service and notifies abnormality.

Moreover, the transition determination process when the transition condition of Case C is the symbol j3 will be explained. In this case, the transition determining unit 123 determines that it does not match the transition condition j3 because the end schedule period has passed although the end status of the monitoring target<1>is “Success”. The transition determining unit 123 does not transition to the next service and notifies abnormality.

Next, the transition determination process when the transition condition of Case D is the symbol j1 will be explained. In Case D, the execution state of the monitoring target<1>becomes “ended” before “13:39”, and the status becomes “Success”. Suppose that the execution state of the monitoring target<2> is “executing”. In this case, the transition determining unit 123 determines it does not match the transition condition j1 because the end status of the monitoring target<1> is “Success” but the end is completed before the end scheduled period. The transition determining unit 123 does not transition to the next service and notifies abnormality.

Furthermore, the transition determination process when the transition condition of Case D is the symbol j2 will be explained. In this case, the transition determining unit 123 determines that it does not match the transition condition j2 because the monitoring target<1>has ended but the end is completed before the end scheduled period. The transition determining unit 123 does not transition to the next service and notifies abnormality.

Moreover, the transition determination process when the transition condition of Case D is the symbol j3 will be explained. In this case, the transition determining unit 123 determines that it does not match the transition condition j3 because the end status of the monitoring target<1> is “Success” but the end is completed before the end scheduled period. The transition determining unit 123 does not transition to the next service and notifies abnormality.

### Still Another Example of Transition Determination Process

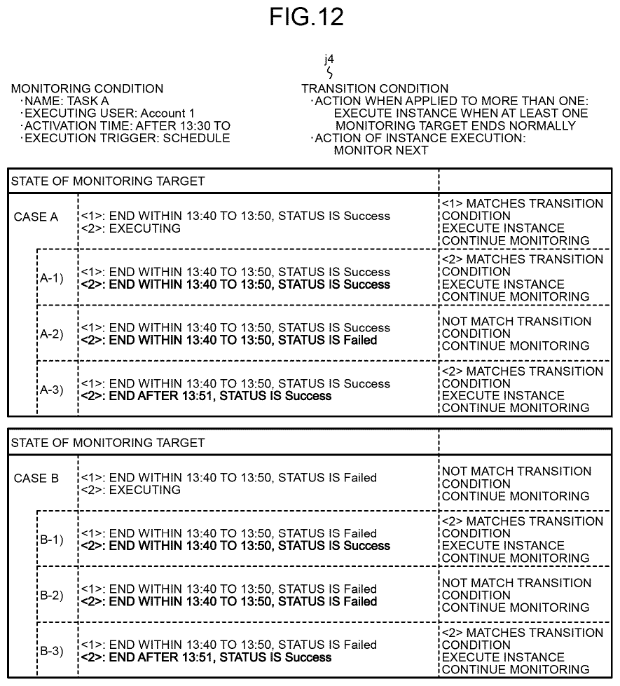

Next, another example of the transition determination process performed by the transition determining unit 123 will be explained referring to FIG. 12. FIG. 12 is a diagram illustrating still another example of the transition determination process according to the embodiment. The monitoring target is two instances of “task A” illustrated in FIG. 9, similarly to the cases in FIG. 10 and FIG. 11. In this example also, the task A represented by the symbol i1 is referred to as <1> and the task A represented by the symbol i2 is referred to as <2>, to be distinguished from each other.

In this example, suppose that the monitoring conditions defined in the monitoring condition definition 23 are “task A” as the task name, “Account 1” as the executing user, “from 13:30” as the period in which the task is executed (activation time), and “schedule” as the execution trigger.

Moreover, suppose that the transition condition j4 defined in the transition condition definition 24 is “ended” as the transition condition set in the transition condition item, and “continue” as an action after execution. “Ended” indicates that at least either one of the monitoring targets is normally ended. “Continue” indicates that a next monitoring target is monitored.

The transition determination process when the transition condition of Case A is the symbol j4 will be explained. In Case A, the execution state of the monitoring target<1>becomes “ended” within “13:40 to 13:50” and the status becomes “Success”. Suppose that the execution state of the monitoring target<2> is “executing”. In this case, the transition determining unit 123 determines that it matches the transition condition j4 because the monitoring target<1>has ended normally. The transition determining unit 123 shifts to the transition executing unit 124. The transition executing unit 124 executes a process instance of the job network to transition to the next service. In addition, the transition determining unit 123 continues monitoring of the task A represented by <2>, to monitor the next monitoring target. The task A represented by <1> is excluded from the monitoring target.

Moreover, suppose that time has passed since the state of Case A, and the execution state of the monitoring target<2>becomes “ended” within “13:40 to 13:50” and the status becomes “Success” in Case A-1. In this case, the transition determining unit 123 determines it matches the transition condition j4 because the monitoring target<2>has ended normally. The transition determining unit 123 shifts to the transition executing unit 124. The transition executing unit 124 executes a process instance of the job network to transition to the next service. In addition, the transition determining unit 123 continues monitoring of the next monitoring target. The task A represented by <2> is excluded from the next monitoring target.

Furthermore, suppose that time has passed since the state of Case A, and the execution state of the monitoring target<2>becomes “ended” during the period of “13:40 to 13:50” and the status becomes “Failed” in Case A-2. In this case, the transition determining unit 123 determines it does not match the transition condition j4 because the end status of the monitoring target<2> is “Failed”. The transition determining unit 123 continues monitoring of the next monitoring target. The task A represented by <2> is excluded from the next monitoring target.

Moreover, suppose that time has passed since the state of Case A, and the execution state of the monitoring target<2>becomes “ended” after “13:51” and the status becomes “Success” in Case A-3. In this case, the transition determining unit 123 determines it matches the transition condition j4 because the monitoring target<2>has ended normally. The transition determining unit 123 shifts to the transition executing unit 124. The transition executing unit 124 executes a process instance of a job network to transition to the next service. In addition, the transition determining unit 123 continues monitoring of the next monitoring target. The task A represented by <2> is excluded from the next monitoring target.

Next, the transition determination process when the transition condition of Case B is the symbol j4 will be explained. In Case B, the execution state of the monitoring target<1>becomes “ended” during the period of “13:40 to 13:50” and the status becomes “Failed”. Suppose that the execution state of the monitoring target<2> is “executing”. In this case, because the status of the monitoring target<1> is “Failed”, the transition determining unit 123 determines that it does not match the transition condition j4. The transition determining unit 123 continues monitoring of the next monitoring target. The task A represented by <1> is excluded from the next monitoring target.

Moreover, suppose that time has passed since the state of Case B, and the execution state of the monitoring target<2>becomes “ended” during the period of “13:40 to 13:50” and the status becomes “Success” in Case B-1. In this case, the transition determining unit 123 determines it matches the transition condition j4 because all of the monitoring targets ended normally. The transition determining unit 123 shifts to the transition executing unit 124. The transition executing unit 124 executes a process instance of a job network to transition to the next service. In addition, the transition determining unit 123 continues monitoring of the next monitoring target. The task A represented by <2> is excluded from the next monitoring target.

Furthermore, suppose that time has passed since the state of Case B, and the execution state of the monitoring target<2>becomes “ended” during the period of “13:40 to 13:50” and the status becomes “Failed” in Case B-2. In this case, the transition determining unit 123 determines it does not match the transition condition j4 because the end status of the monitoring target<2> is “Failed”. The transition determining unit 123 continues monitoring of the next monitoring target. The task A represented by <2> is excluded from the next monitoring target.

Moreover, suppose that time has passed since the state of Case B, and the execution state of the monitoring target<2>becomes “ended” after “13:51” and the status becomes “Success” in Case B-3. In this case, the transition determining unit 123 determines it matches the transition condition j4 because the monitoring target<2>has ended normally. The transition determining unit 123 shifts to the transition executing unit 124. The transition executing unit 124 executes a process instance of a job network to transition to the next service. In addition, the transition determining unit 123 continues monitoring of the next monitoring target. The task A represented by <2> is excluded from the next monitoring target.

### Flowchart of Activation Process

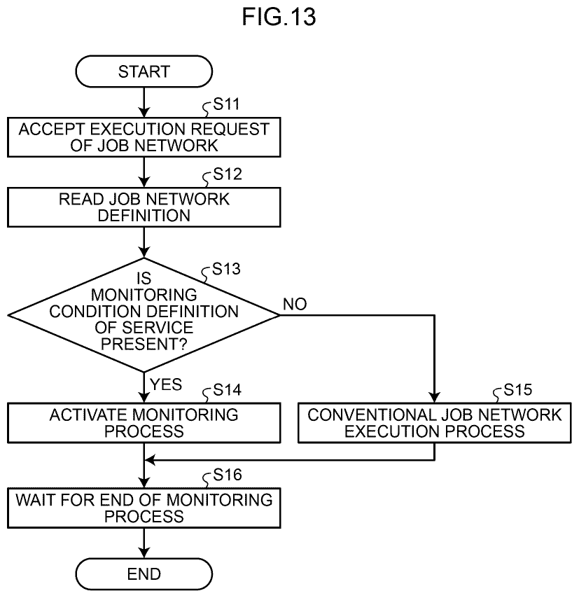

A flowchart of the activation process performed by the activating unit 11 will be explained referring to FIG. 13. FIG. 13 is a diagram illustrating an example of a flowchart of the activation process according to the embodiment.

As illustrated in FIG. 13, the activating unit 11 accepts an execution request of a job network (step S11), and reads the job network definition 21 of the job network (step S12). The activating unit 11 determines whether there is the monitoring condition definition 23 of a service that is used to monitor the service (step S13). For example, the activating unit 11 determines whether there is a specification of the monitoring condition definition 23 in the service monitoring condition item in the read job network definition 21.

When it is determined that there is the monitoring condition definition 23 of the service (step S13: YES), the activating unit 11 activates the monitoring process (step S14). The activation of the monitoring process is performed to monitor a monitoring target defined in the monitoring condition definition 23 of the service. The activating unit 11 shifts to step S16.

On the other hand, when it is determined that there is no monitoring condition definition 23 of the service (step S13: NO), the activating unit 11 performs the execution process of a conventional job network (step S15). The activating unit 11 then shifts to step S16.

At step S16, the activating unit 11 waits until the end of the monitoring process (step S16). The activating unit 11 ends the activation process.

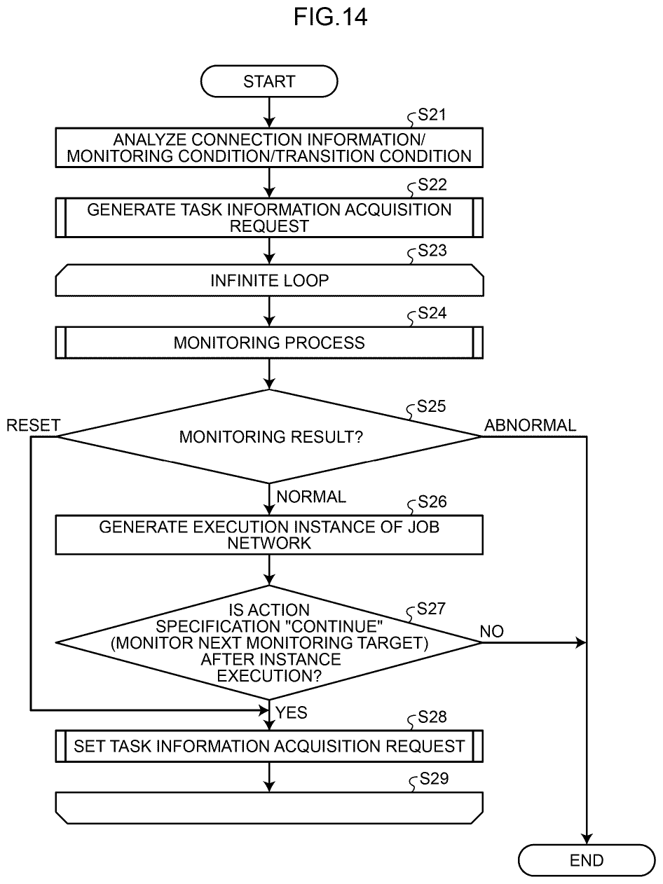

Flowchart of Monitoring Processing process Next, a flowchart of the monitoring processing process performed by the monitoring-process processing unit 12 will be explained referring to FIG. 14. FIG. 14 is a diagram illustrating an example of a flowchart of the monitoring processing process according to the embodiment.

As illustrated in FIG. 14, the monitoring-process processing unit 12 analyzes the connection information/the monitoring condition/the transition condition (step S21). For example, the monitoring-process processing unit 12 analyzes the connection information definition 22, the monitoring condition definition 23, and the transition condition definition 24 that are associated with the connection information item, the service monitoring item, and the transition condition item, respectively defined in the job network definition 21. The monitoring-process processing unit 12 generates an information acquisition request of a task of a monitoring target to the target service (step S22). The generation processing of the task information acquisition request will be described later.

Subsequently, the monitoring-process processing unit 12 loops infinitely between step S23 and step S29. The monitoring-process processing unit 12 executes the monitoring process of a task of the monitoring target (step S24). The monitoring process will be described later.

When the monitoring result is “reset” (step S25: “RESET”), the monitoring-process processing unit 12 shifts to step S28 to re-set the information acquisition request of the task. Moreover, when the monitoring result is “abnormal” (step S25: ABNORMAL), the monitoring-process processing unit 12 ends the monitoring processing process.

Furthermore, when the monitoring result is “normal” (step S25: NORMAL), the monitoring-process processing unit 12 generates an execution instance of a job network (step S26). The monitoring-process processing unit 12 determines whether an action specification of the instance execution is “continue” (monitor a next monitoring target) (step S27). The action specification of the instance execution is set in an action item after execution of the transition condition definition 24. When it is determined that the action specification of the instance execution is “continue” (step S27: YES), the monitoring-process processing unit 12 shifts to step S28 to reset the information acquisition request of a task.

On the other hand, when the action specification of the instance execution is not “continue”, namely, when it is determined to be “end” (step S27: NO), the monitoring-process processing unit 12 ends the monitoring processing process.

### Flowchart of Request Generation Process

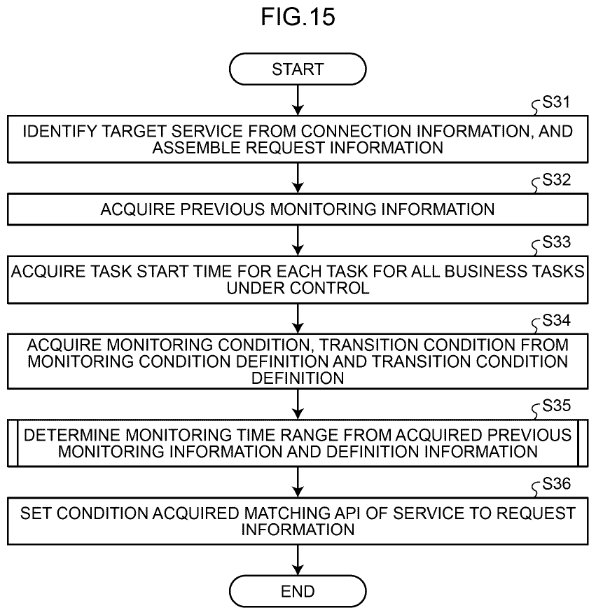

Next, a flowchart of the request generation process to generate an information request of a task will be explained referring to FIG. 15. FIG. 15 is a diagram illustrating an example of the flowchart of the request generation process according to the embodiment.

As illustrated in FIG. 15, the monitoring-process processing unit 12 identifies a target service from the connection information, and assembles request information (step S31). For example, the monitoring-process processing unit 12 identifies a target service from settings of the connection destination and the header defined in the connection information definition 22 corresponding to the target job network. The monitoring-process processing unit 12 acquires API information (specification parameter, specification method) for information acquisition of the identified service from the service information 26. A monitoring process processing unit 12 assembles a task information acquisition request to a target service.

The monitoring-process processing unit 12 refers to the monitoring history 25, and acquires the previous monitoring history corresponding to the target job network (step S32).

Subsequently, the monitoring-process processing unit 12 acquires a start time of a business task for each task from the control device 1 for all business tasks under the management of the target job network (step S33). This is because a case is assumed that multiple tasks are processed within a single job network. Note that when the start time varies depending on a business task, the monitoring-process processing unit 12 may choose the latest time as the start time of the business task.

The monitoring-process processing unit 12 acquires the monitoring condition and the transition condition from the monitoring condition definition 23 and the transition condition definition 24 (step S34). The monitoring-process processing unit 12 determines the monitoring time range from the acquired previous monitoring information, the definition information (transition condition, transition condition) (step S35). The monitoring-time-range determination process will be described later.

The monitoring-process processing unit 12 sets the condition acquired to match the API of the service to the request information (step S36). For example, the monitoring-process processing unit 12 sets the determined monitoring time range in the information acquisition request of a task for the target service. The monitoring-process processing unit 12 ends the request generation process.

### Flowchart of Monitoring-Time-Range Determination Process

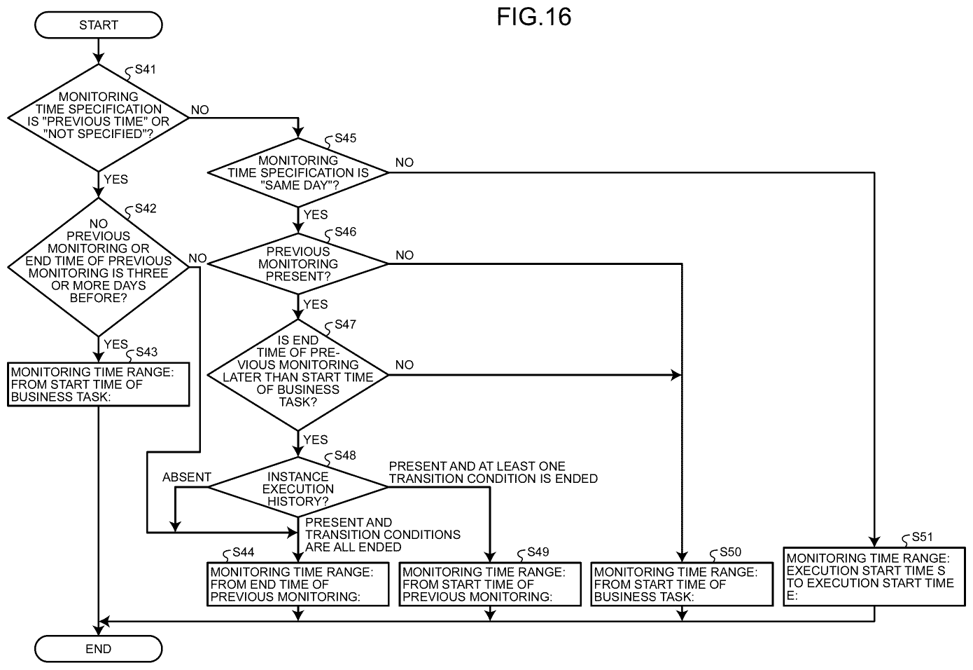

Next, a flowchart of the process of determining the monitoring time range will be explained referring to FIG. 16. FIG. 16 is a diagram illustrating an example of a flowchart of the monitoring-time-range determination process.

As illustrated in FIG. 16, the monitoring-process processing unit 12 determines whether the monitoring time specification set in the monitoring condition is “previous (after previous monitoring) or “not specified” (step S41). When it is determined that the monitoring time specification is “previous” or “not specified” (step S41: YES), the monitoring-process processing unit 12 determines whether the previous monitoring being absent (the monitoring condition is used for the first time) or the end time of the previous monitoring is three or more days before (there is a gap from the previous use) (step S42). The presence or absence of the previous monitoring may be determined based on whether the previous monitoring information corresponding to the target job network is present in the monitoring history 25. As for the end time of the previous start, the end time of the monitoring target in the previous monitoring information corresponding to the target job network stored in the monitoring history 25 may be referred.

When it is determined that the previous monitoring is absent (the monitoring condition is use for the first time) or that the end time of the previous monitoring is three or more days before (step S42: YES), the monitoring-process processing unit 12 calculates the monitoring time range as “from a start time of a business task” (step S43). This is because it has never been monitored since the start of the business task. The monitoring-process processing unit 12 then ends the monitoring-time-range determination process.

On the other hand, when it is determined that the previous monitoring is present and the end time of the previous monitoring is not three or more days before (step S42: NO), the monitoring-process processing unit 12 calculates the monitoring time range as “the end time of the previous monitoring (monitoring time range_E) (step S44). This is to avoid monitoring during the same time period. The monitoring-process processing unit 12 then ends the monitoring-time-range determination process.

At step S41, when the monitoring time specification is not “previous” nor “not specified” (step S41: NO), the monitoring-process processing unit 12 determines whether the monitoring time specification is “same day” (step S45). When it is determined that the monitoring time specification if not “same day” (step S45: NO), the monitoring-process processing unit 12 calculates the monitoring time range as “execution start time S to execution start time E” because the monitoring time specification is “specified time” (step S51). The execution start time S and the execution start time E are defined in the monitoring condition. The monitoring-process processing unit 12 then ends the monitoring-time-range determination process.

On the other hand, when it is determined that the monitoring time specification is “same day” (step S45: YES), the monitoring-process processing unit 12 determines whether the previous monitoring is present (step S46). The presence or absence of the previous start may be determined based on whether the previous monitoring information corresponding to the target job network is present in the monitoring history 25. When it is determined that the previous monitoring is not present (step S46: NO), the monitoring-process processing unit 12 calculates the monitoring time range as “from a start time of a task” (step S50). This is because monitoring is not performed on the same day. The monitoring-process processing unit 12 then ends the monitoring-time-range determination process.

On the other hand, when it is determined that the previous monitoring is present (step S46: YES), the monitoring-process processing unit 12 determines whether the end time of the previous monitoring is later than the start time of the business task (step S47). When it is determined that the end time of the previous monitoring is earlier than the start time of the business task (step S47: NO), the monitoring-process processing unit 12 shifts to step S50 to set the monitoring time range to “from a start time of a business task”.

On the other hand, when it is determined that the end time of the previous monitoring is later than the start time of the business task (step S47: YES), the monitoring-process processing unit 12 determines whether an execution history of an instance is present (step S48). When it is determined that there is the execution history of an instance is absent (step S48: ABSENT), the monitoring-process processing unit 12 shifts to step S44 to set the monitoring time range to “from an end time of previous monitoring”.

Moreover, when it is determined that the execution history of an instance is present (step S48: PRESENT), the monitoring-process processing unit 12 shifts to step S44 to set the monitoring time range to “from an end time of previous monitoring” when the transition condition indicates all ended.

Furthermore, when it is determined that the execution history of an instance is present (step S48: PRESENT), the monitoring-process processing unit 12 calculates the monitoring time range as “from a start time of previous monitoring” when the transition condition indicates that at least one is ended (step S49). The monitoring-process processing unit 12 then ends the monitoring-time-range determination process.

### Flowchart of Monitoring Process

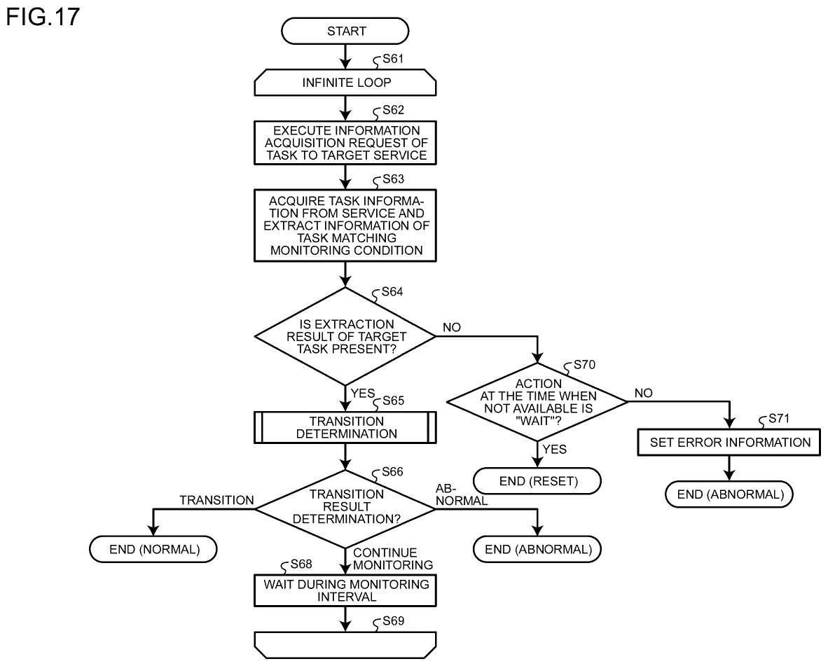

Next, a flowchart of the monitoring process will be explained referring to FIG. 17. FIG. 17 is a diagram illustrating an example of a flowchart of the monitoring process according to the embodiment.

As illustrated in FIG. 17, the monitoring-process processing unit 12 loops infinitely between step S61 and step S69. The monitoring-process processing unit 12 executes the monitoring process of a task of the monitoring target (step S62). The monitoring-process processing unit 12 executes the information acquisition request of a task to the target service (step S62). The monitoring-process processing unit 12 acquires task information of the target service, and extracts information of a task that matches the monitoring condition (step S63). For example, the monitoring-process processing unit 12 acquires the extraction method of information needed for the target service from information defined in the service information 26, and acquires the task information using the acquired information. The monitoring-process processing unit 12 refers to the task name, the execution start time S, the execution start time E, the execution trigger, and the executing user defined in the monitoring condition definition 23, and extracts information of the task that matches the monitoring condition from the acquired task information.

The monitoring-process processing unit 12 determines whether an extraction result of the target task is present (step S64). When it is determined that an extraction result of the target task is present (step S64: YES), the monitoring-process processing unit 12 executes the transition determination process (step S65). The transition determination process will be described later.

The monitoring-process processing unit 12 performs transition result determination (step S66). When the transition result is determined as “transition” (step S66: “TRANSITION”), the monitoring-process processing unit 12 returns to the monitoring processing process, regarding the monitoring result as “normal”.

Moreover, when the transition result is determined as “continue” (step S66: CONTINUE MONITORING), the monitoring-process processing unit 12 waits for a monitoring interval (step S68). For example, the monitoring-process processing unit 12 waits for a period corresponding to the monitoring interval in the target monitoring condition in the monitoring condition definition 23. The monitoring-process processing unit 12 shifts to step S69 to continue monitoring.

Furthermore, when the transition result is determined as “abnormal” (step S66: ABNORMAL), the monitoring-process processing unit 12 returns to the monitoring process, regarding the monitoring result as “abnormal”.

At step S64, when it is determined that an extraction result is not present (step S64: NO), the monitoring-process processing unit 12 determines whether the action when not available is “WAIT” (step S70). When it is determined that the action when not available is “WAIT” (step S70: YES), the monitoring-process processing unit 12 returns to the monitoring processing process, regarding the monitoring result as “reset” to reset the information acquisition request of the task.

On the other hand, when the action when not available is determined as not “WAIT” (being “ABORT”) (step S70: NO), the monitoring-process processing unit 12 sets the error information (step S71). The monitoring-process processing unit 12 ten returns to the monitoring processing process, regarding the monitoring result as “abnormal”.

### Flowchart of Transition Determination Process

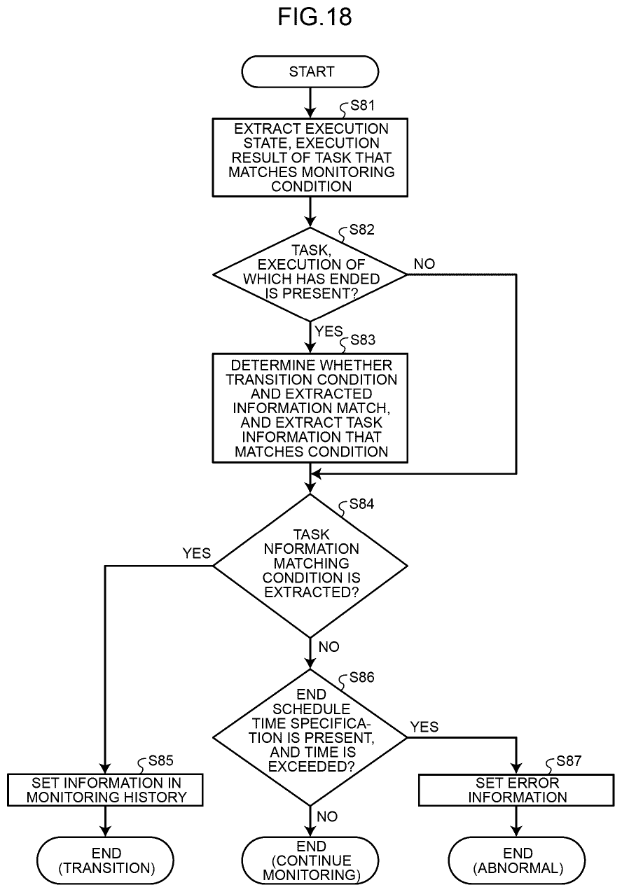

Next, a flowchart of the transition determination process will be explained referring to FIG. 18. FIG. 18 is a diagram illustrating an example of the flowchart of the transition determination process according to the embodiment.

As illustrated in FIG. 18, the monitoring-process processing unit 12 extracts the execution state and the execution result of a task of the monitoring target that matches the monitoring condition from the extraction result of the target task (step S81). The execution result determines whether there is a task that has ended the execution (step S82). When it is determined that there is no task that has ended execution (step S82: NO), the monitoring-process processing unit 12 shifts to step S84.

On the other hand, when it is determined that there is a task that has ended execution (step S82: YES), the monitoring-process processing unit 12 determines whether the transition condition defined in the transition condition definition 24 and the extracted information match each other, and extracts the task information that matches the condition (step S83). For example, the monitoring-process processing unit 12 determines whether it matches the transition condition of the transition condition definition 24 using the execution result of the task, the execution state of which indicates an end. When it matches the transition condition, the transition determining unit 123 extracts the task information the task matching the condition. The monitoring-process processing unit 12 shifts to step S84.

At step S84, the monitoring-process processing unit 12 determines whether the task information matching the condition is extracted (step S84). When it is determined that the task information matching the condition is extracted (step S84: YES), the monitoring-process processing unit 12 stores the target task information in the monitoring history 25 as the previous monitoring information (step S85). The monitoring-process processing unit 12 returns the monitoring result to the monitoring process as “transition”.

On the other hand, when it is determined that the task information that matches the condition is not extracted (step S84: NO), the monitoring-process processing unit 12 determines whether there is a specification for the end scheduled time, and whether the end scheduled time has exceeded (step S86). When it is determined that the end scheduled time has not exceeded (step S86: NO), the monitoring-process processing unit 12 returns the monitoring result to the monitoring process as “continue monitoring”.

On the other hand, when it is determined that the end scheduled time has exceeded (step S86: YES), the monitoring-process processing unit 12 sets the error information (step S87). The monitoring-process processing unit 12 then returns the monitoring result to the monitoring process as “abnormal”

### Effect of Embodiment

According to the embodiment described above, the control device 1 determines whether the monitoring condition in which a condition for monitoring the monitoring target that operates on a service is set is defined in a job flow using a plurality of services. When it is determined that the monitoring condition is defined in the job flow, the control device 1 monitors the service based on the monitoring condition. The control device 1 transitions to the next service following the service based on the job flow when the transition condition in which a condition for transitioning the service to the next service is satisfied as a result of the monitoring. Thus, the control device 1 enables linkage of services without modifying the service.

Moreover, in the control device 1, the process of monitoring a service acquires task information indicating a state of multiple tasks from the service. The process of monitoring the service extracts a task that matches the monitoring target included in the monitoring condition from the task information. The process of monitoring a service monitors a state of the extracted task. Thus, the control device 1 can monitor a monitoring target of the service without modifying the service.

Furthermore, in the control device 1, the process of acquiring the task information generates request information that is a request information varying for each service and that is used to acquire the task information, by using the information regarding the service associated with the job flow. The process of acquiring the task information calculates a monitoring time range of this time based on the previous monitoring history information stored at least for each job flow. The process of acquiring the task information sets the calculated monitoring time range of this time in the request information. The process of acquiring task information requests the request information acquired by setting to the service. The process of acquiring the task information acquires the task information corresponding to the request information from the service. Thus, the control device 1 can monitor task information of a service effectively by using the monitoring time range.

Furthermore, in the control device 1, the process of calculating a monitoring time range of this time sets, when there is an execution history indicating that transition to the next service has been executed in the previous monitoring history information corresponding to the job flow, the start time of the monitoring time range of this time to the end time of the previous monitoring time. Thus, the control device 1 can avoid monitoring in the same time period.

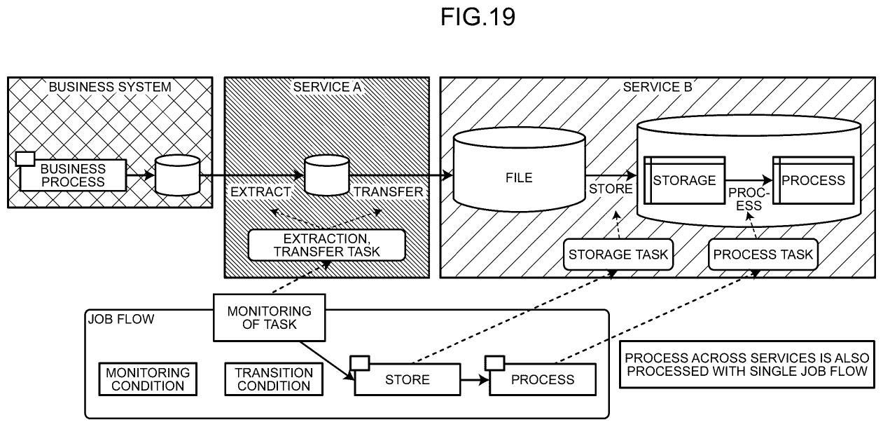

An example of an effect of the service linkage control according to the embodiment will be explained referring to FIG. 19. FIG. 19 is a diagram illustrating an example of the effect of the service linkage control according to the embodiment. As illustrated in FIG. 19, the control device 1 enables service linkage without modifying the service by executing a job (business task) performed in multiple services using the transition condition and the monitoring condition set in the job flow (job network). That is, the control device 1 can perform process processing by the service B with the latest data after all data transferred by the service A have collected, by using the transition condition and the monitoring condition. Moreover, the control device 1 can execute the processing process by the service B with the latest data after all data transferred by the service A is collected by using the transition condition and the monitoring condition even when a business task is executed from multiple business systems. In addition, the control device 1 can perform processing by a single job flow by freely combining multiple services.

The illustrated respective components of the control device 1 are not necessarily configured physically as illustrated. That is, specific forms of distribution and integration of the control device 1 are not limited to the ones illustrated, and all or some thereof can be configured to be distributed or integrated functionally or physically in arbitrary units according to various kinds of loads, usage conditions, and the like. Moreover, the storage unit 20 may be configured to be connected through a network as an external device of the control device 1.

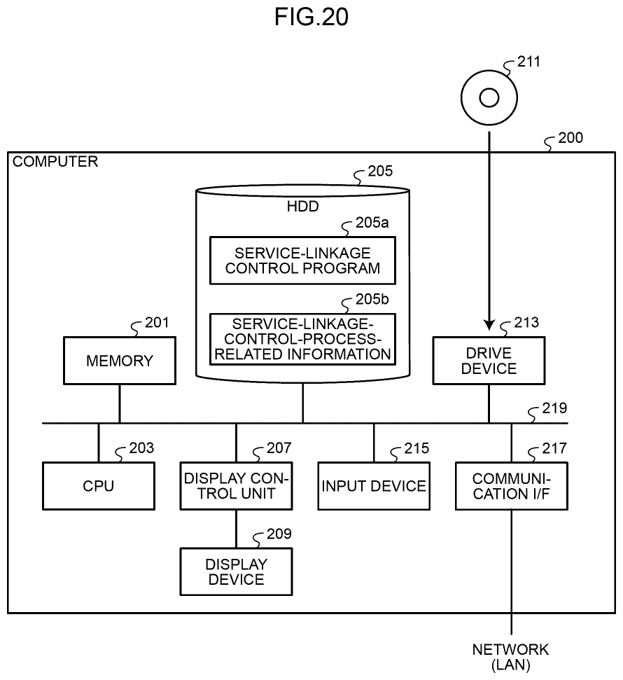

Moreover, the respective processes explained in the embodiment described above can be implemented by executing a program prepared in advance by a computer, such as a personal computer and a workstation. Therefore, in the following, a computer that executes a service-linkage control program implementing functions similar to those of the control device 1 illustrated in FIG. 2 will be explained. Herein, a service-linkage control program that implements functions similar to those of the control device 1 will be explained as an example. FIG. 20 is a diagram illustrating an example of the computer that executes the service-linkage control program.

As illustrated in FIG. 20, the computer 200 includes central processing unit (CPU) 203 that executes various kinds of arithmetic processing, an input device 215 that accepts input of data from a user, and a display device 209. Furthermore, the computer 200 includes a drive device 213 that reads a program and the like from a storage medium, and a communication interface (I/F) 217 that performs data exchange with another computer through a network. Moreover, the computer 200 includes a memory 201 that temporarily stores various kinds of information, and a hard disk drive (HDD) 205. The memory 201, the CPU 203, the HDD 205, the display control unit 207, the display device 209, the drive device 213, the input device 215, and the communication I/F 217 are connected through a bus 219.

The drive device 213 is a device for, for example, a removable disk 211. The HDD 205 stores a service-linkage control program 205a and a service-linkage-control-process-related information 205b. The communication I/F 217 manages the interface between a network and internal components of the device, and controls input and output of data from another computer. For the communication I/F 217, for example, a modem, a LAN adapter, and the like can be adopted.

The display device 209 is a display device that displays data, such as a document, an image, and functional information, including a cursor, an icon, and a toolbox. For the display device 209, for example, a liquid crystal display, an organic electroluminescence (EL) display, and the like can be adopted.

The CPU 203 reads the service-linkage control program 205a, loads on the memory 201, and executes as a process. The process corresponds to each functional unit of the control device 1. The service-linkage-control-process-related information 205b includes information stored in the storage unit 20. Furthermore, for example, the removable disk 211 stores various information such as the service-linkage control program 205a.

The service-linkage control program 205a is not necessarily stored in the HDD 205 from the beginning. For example, the program is stored in a “portable physical medium” such as a flexible disk (FD), a CD-ROM, a DVD disk, a magneto optical disk, and an IC card, inserted into the computer 200. It may be configured such that the computer 200 reads and executes the service-linkage control program 205a therefrom.

Furthermore, the processing performed by the control device 1 explained in the embodiment described above is applicable to operation of a business system that executes a business task by integrating multiple services.

According to one embodiment, services can be linked without modifying a service.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a service-linkage control program that causes a computer to execute a process comprising:
determining whether a monitoring condition in which a condition for monitoring a monitoring target that operates on a service is set is defined in a job flow using a plurality of services;
monitoring a service based on the monitoring condition when it is determined that the monitoring condition is defined in the job flow; and
transitioning, when a transition condition in which a condition for the service to transition to a next service is set is satisfied as a result of the monitoring, the service to the next service based on the job flow.

2. The non-transitory computer-readable recording medium according to claim 1, wherein
the monitoring the service includes:
acquiring task information that indicates a state of a plurality of tasks from the service;
extracting a task that matches the monitoring target included in the monitoring condition from the task information; and
monitoring a state of the extracted task.

3. The non-transitory computer-readable recording medium according to claim 2, wherein
the acquiring the task information includes:
generating request information that is request information varying for each of the services and that is used to acquire the task information, using information relating to a service associated with the job flow;
calculating a monitoring time range of this time based on previous monitoring history information stored at least for each of the job flow;
setting the calculated monitoring time range of this time to the request information;
requesting the request information acquired at setting to the service; and
acquiring the task information corresponding to the request information from the service.

4. The non-transitory computer-readable recording medium according to claim 3, wherein the calculating the monitoring time range of this time includes setting a start time of the monitoring time range of this time to an end time of a previous monitoring time when an execution history indicating to transition to a next service is present in the monitoring history information of the previous time corresponding to the job flow.

5. A service-linkage control method comprising:
determining whether a monitoring condition in which a condition for monitoring a monitoring target that operates on a service is set is defined in a job flow using a plurality of services;
monitoring a service based on the monitoring condition when it is determined that the monitoring condition is defined in the job flow; and
transitioning, when a transition condition in which a condition for the service to transition to a next service is set is satisfied as a result of the monitoring, the service to the next service based on the job flow, by a processor.

6. A service-linkage control system comprising:
an information processing apparatus;
a first service that executes a first task; and
a second service that executes a second task, wherein
the information processing apparatus includes a processor configured to:
determine whether a monitoring condition in which a condition for monitoring a monitoring target that operates on a service is set is defined in a job flow using the first service and the second service;
monitor the first service based on the monitoring condition when it is determined that the monitoring condition is defined in the job flow; and
transition, when a transition condition in which a condition for the first service to transition to the second service is set is satisfied as a result of the monitoring, to the second service based on the job flow.
